(19) United States
(12) Patent Application Publication
(10) Pub. No.: US 2023/0159176 A1
(43) Pub. Date: May 25, 2023

(54) MOTOR DRIVE SYSTEM

(71) Applicant: GKN Aerospace Services Limited, Shirley, Solihull (GB)

(72) Inventor: Simon Taylor, Shirley, Solihull (GB)

(21) Appl. No.: 17/920,096

(22) PCT Filed: Apr. 29, 2021
(86) PCT No.: PCT/GB2021/051030

§ 371 Date: Oct. 20, 2022

(30) Foreign Application Priority Data
Apr. 29, 2020 (GB) 2006278.2

(51) Int. Cl. B64D 27/24; H02K 55/00; H02K 7/14; B60L 50/71; B64D 33/08; B60L 58/33; H01M 8/04029

(52) U.S. Cl. CPC B64D 27/24; B60L 50/71; B60L 58/33; B64D 33/08; H01M 8/04029; H02K 7/14; H02K 55/00; B60L 2200/10; H01M 2250/20

(57) ABSTRACT

The present disclosure relates to a motor drive system comprising: a fuel cell; a motor, electrically connected to the fuel cell; and, a cryogenic system arranged to contain a cryogen, wherein the fuel cell is arranged to output current to the motor, and wherein the cryogenic system is arranged to communicate a cryogen from the cryogenic system to the fuel cell.

### CROSS-REFERENCE TO RELATED APPLICATIONS

This application is a national stage of, and claims priority to, Patent Cooperation Treaty Application No. PCT/GB2021/051030, filed on Apr. 29, 2021, which application claims priority to Great Britain Application No. GB 2006278.2, filed on Apr. 29, 2020, which applications are hereby incorporated herein by reference in their entireties.

### BACKGROUND

The present disclosure is concerned with motor drive systems. The efficiency of motor drives systems is of interest due to the environmental impact of inefficient drive systems. Motor drive systems may be used in the operation of both land-based and airborne vehicles.

According to most estimates, airline traffic is set to double every fifteen years providing a significant increase in the operation of airborne motor drive systems. Inefficient drive systems lead to greater usage of resources to generate the drive required to account for the inefficient system. As such, usage of resources (such as kerosene) can be reduced by the development of more efficient systems. Emissions from many drive systems are known to be harmful whether produced at ground level or at altitude.

Though use of alternative fuels is known and these provide advantages over present fuels, there are areas of motor drive systems which can be improved upon. As there are a number of elements within even the most simplistic motor drive system, any attempt to improve the efficiency of a motor drive system has a large number of possible starting options.

Therefore, despite a number of advances in the improvement of efficiencies of motor drive systems, there remains the desire for a more efficient system. The present disclosure described a motor drive system which has a wide range of previously unavailable advantages which are described herein.

### SUMMARY OF THE INVENTION

Viewed from a first aspect there is provided in this disclosure a motor drive system comprising: a fuel cell; a motor, electrically connected to the fuel cell; and, a cryogenic system arranged to contain a cryogen, wherein the fuel cell is arranged to output current to the motor, and wherein the cryogenic system is arranged to communicate a cryogen from the cryogenic system to the fuel cell.

Viewed from a second aspect there is provided an aircraft comprising the motor drive system of the first aspect.

Viewed from a third aspect there is provided a method of operating a motor, the method comprising: providing a fuel cell; providing a motor; providing an electrical connection between the fuel cell and the motor; providing a cryogen to the fuel cell; providing a cryogen to the fuel cell; and, outputting electrical power direct from the fuel cell to the motor.

Viewed from a fourth aspect there is provided an aircraft propulsion apparatus comprising: a propeller arranged to generate thrust on rotation in air; and, a motor drive system arranged to cause rotation of the propeller, the motor drive system comprising: a fuel cell; a motor, electrically connected to the fuel cell; and, a cryogenic system arranged to contain a cryogen, wherein the fuel cell is arranged to output current to the motor, and wherein the cryogenic system is arranged to communicate a cryogen from the cryogenic system to the fuel cell.

### BRIEF DESCRIPTION OF THE DRAWINGS

One or more embodiments of the disclosure will now be described, by way of example only, and with reference to the following figures in which:

FIG. 1 shows a schematic of a motor drive system;

FIG. 2 shows a schematic of a motor drive system according to an example of the present disclosure;

FIG. 3A shows a schematic of a portion of a motor for a motor drive system according to an example of the present disclosure;

FIG. 3B shows a schematic of a portion of a motor for a motor drive system according to an example of the present disclosure;

FIG. 4 shows a schematic of a portion of a motor for a motor drive system according to an example of the present disclosure;

FIG. 5 shows a schematic arrangement of a motor drive system according to an example of the present disclosure; and,

FIG. 6 shows a schematic of a motor drive system according to an example of the present disclosure arranged within a portion of an aircraft.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The disclosure is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

The present disclosure is concerned with motor drive systems and specifically to aircraft motor drive systems which can provide improvements on current efficiencies.

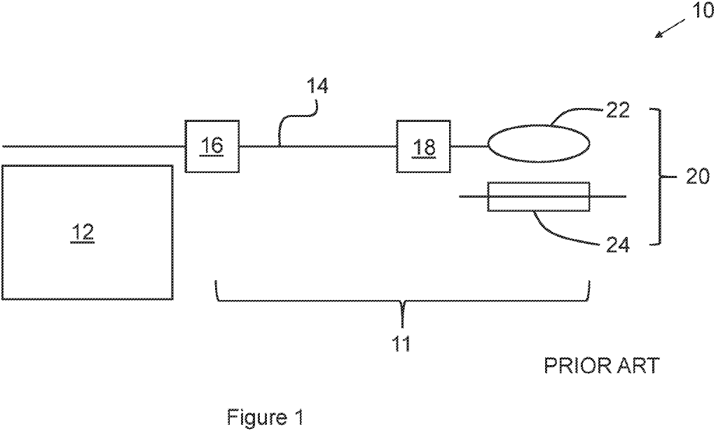

FIG. 1 shows a schematic of a motor drive system 10. The modern motor drive system 100 may have an electricity source 12 which produces electrical power. The electrical power is passed along electrical conduit 14. The electrical conduit 14 has a transformer 16, 18 arranged at either end (electricity source 12 end and motor 20 end). The electrical power is transformed so as to reduce the losses of the electrical power along the length of the electrical conduit 14. Such losses may come from eddy currents or the like. Indeed, the transformers 16, 18 reduce losses due to the joule effect associated with the transfer of high current, where high voltage is preferred to high current in conventional systems 10.

The electrical power from the electricity source 12 is stepped up (the voltage is increased and the current lowered) by the first transformer 16 prior to travelling along the electrical conduit 14. This travel stage may be across a relatively large distance and so lowering the current prior to travelling along this distance reduces electrical losses. The electrical power is then stepped down (voltage is lowered and current increased) by the second transformer 18 prior to being supplied to the motor 20. The motor 20 shown comprises a stator 22 and a rotor 24.

This present system 10 enables electrical power to be supplied to a motor 20 so that propulsive power may be generated. In an example, the electricity source 12 may be a fuel cell. In a specific example, the system 10 shown in FIG. 1 may have a system portion 11 which includes the electrical conduit 14, the transformers 16, 18, and the motor 20. This system portion 11 has an efficiency which can be assessed. The electrical conduit 14 typically has an efficiency of around 98%, the transformers 16, 18 typically have an efficiency of around 98%, and the motor typically has an efficiency of 97%. This system portion 11 therefore has an overall efficiency of around 92%.

In place of the transformers 16, 18, the arrangement 10 may have the fuel cell 12 arranged so as to produce sufficiently low current so as to avoid the above joule heating, however this still results in a reduced overall system efficiency, as the fuel cell 12 preferentially produces high current. This arrangement 10 may use a balance of a plant controller and some power conditioning at the output. Such power conditioning may be partially controlled using an intermediate electrical storage element, such as a battery or the like. The inclusion of these features again reduces the overall efficiency of the system portion 11.

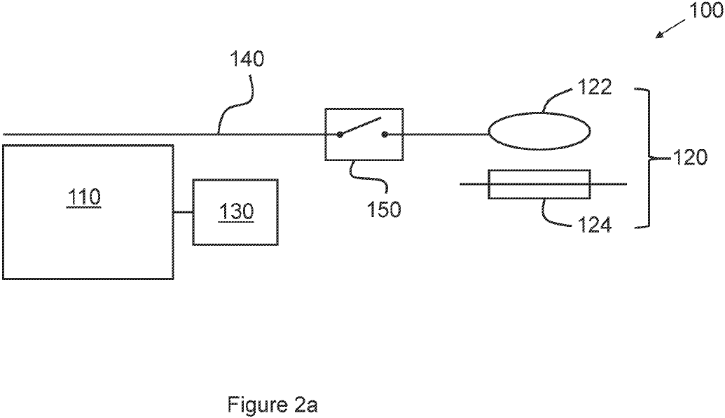

FIG. 2a shows a schematic of a motor drive system 100 according to an example of the present disclosure. The motor drive system 100 shown has an electricity source 110. The electricity source 110 may be a fuel cell 110. The motor drive system 100 has a motor 120 which is electrically connected to the fuel cell 110. The motor drive system 100 has a cryogenic system 130 which is arranged to contain a cryogen. , the cryogenic system 130 is arranged to communicate a cryogen from the cryogenic system 130 to the fuel cell 110. This cryogen may reduce the temperature of the fuel cell 110.

The motor drive system 100 shown also has an electrical conduit 140 to electrically connect the fuel cell 110 to the motor 120. The motor drive system 100 shown also has a switch 150 arranged on the electrical conduit 140 which can controllably, and reversibly, break the electrical connection between the fuel cell 110 and the motor 120. The motor drive system 100 may have a plurality of switches 150. The switch 150 may be used for safety in shutting down the system 100. The switch 150 may in an example be a contactor. Different architectures (shown in FIGS. 2a and 2b) show different arrangements which enable safety in different ways. In FIG. 2b, an inverter 118 is shown between the fuel cell 110 and the motor 120.

In an embodiment, the inverter 118 (and/or a converter) may be used to change the voltage or current of the output from the fuel cell 110. This output may be provided to the motor 120. The inverter 118 (or power electronics) for the motor 120 or the stator coil may be built into the same unit. For example, the inverter 118 may be integrated or built into the motor 120. In an example wherein the inverter 118 is built into the motor 120, the inverter 118 and the stator windings may share the same cryocircuit. A cryocircuit may be a circuit that is cryogenically cooled or may be the arrangement of conduits carrying the cryogen to allow cryogenic cooling of components. Such components may be the motor, inverter and stator windings for example. The inverter 118 may allow a controllably changing magnetic field in the motor 120. The switch 150 and/or the inverter 118 can act to isolate back EMF from stator coils. This advantageously provides a safety function against energy going back into the system.

The cryogenic system 130 may be arranged to contain a cryogen. The cryogen may be a liquid or a gas. The cryogen may be any of liquid hydrogen (LH₂) or liquid nitrogen (LN) or Liquid Helium (LHE) or Liquid Natural Gas (LNG) or the like. The cryogenic system 130 may supply a liquid cryogen to the fuel cell 110 for generation of electrical power. By “supply...”, “provide...” or “communicate a cryogen” to various elements, it is meant herein that the cryogen is moved, or allowed to move, into some proximity of the elements so as to be in thermal communication with the elements resulting in the transferral of thermal energy away from the element and into the cryogen. This communication of the cryogen to the element causes a reduction in a temperature of the element.

Herein terms such as “cryogen”, “cryogenic substance” and “cryogenic source” may be used interchangeably to refer to the actual substance that is of a cryogenic temperature. Such a substance would in most arrangements be contained within a tank or container or the like. A cryogenic temperature clearly depends on the substance in question however cryogenic behaviour has been observed in substances up to -50° C. Therefore, cryogenic temperature is taken herein to refer to temperatures below -50° C.

As used herein, the term cryogenic source or cryogen is deemed to be a non-restricting term and so may refer to any of liquid hydrogen, liquid natural gas, liquid nitrogen, liquid helium, and the like. The cryogen need not necessarily be only one of the above list. In an example, H₂ may be used as a fuel source, while cryogenic cooling is supplied by, e.g., liquid nitrogen.

The electrical conduit 140 along which the electrical power is conducted from the fuel cell 110 to the motor 120 may be supercooled by cryogen supplied by the cryogenic system 130 to reduce transmission losses. It may be advantageous to avoid freezing of the stacks. An option for preventing freezing is to utilise the heat released in the system and route it to prevent freezing. The temperature of the water may be controlled so that water formed is below the dew point but above the freezing point. This will prevent the water freezing upon contact with a surface. Other methods to prevent freezing include arranging any surface which the water may contact to be above the freezing point of water. The thermoelectrical design of the system can be controlled to ensure that heat produced in the system is routed within the cells and stacks to prevent freezing.

A further technique involves controlling the inlet properties as well as the expansion of air in the system. Such expansion can drop the temperature of the walls which can lead to water freezing on the cold surfaces. As such, air expansion should be controlled and limited. Control should be exacted over quite how hydrogen and oxygen are allowed to pass through plates of the fuel cell 110. Such control can be provided by a series of valves and conduits or the like for controlling the air flow in the system.

The cryogenic system 130 may also communicate cryogen to the motor 120 so as to cool the motor 120. Cooling of the motor 120 may entail passing the cryogen within thermal communication of the motor 120 so as to lower the temperature of the motor 120. In particular the cryogen may pass within thermal communication of the motor 120 to cool the stator coils/windings. The cryogen may be passed in a conduit or the like to enable recycling of the cryogen once some heat has been removed from the motor 120 and/or the electrical conduit 140. As the cryogen is heated, some cryogen may become suitable for usage as fuel in the fuel cell. This is an efficient method of providing cooling and fuel to a fuel cell 110.

In the arrangement shown in FIG. 2, operation of the fuel cell 110 generates electrical power which, subsequently, provides drive to the stator 122 of the motor 120. In the example shown, the fuel cell 110 operates to provide electrical power. This electrical power is at a high current and travels along the electrical conduit 140 at high current to the motor 120. The losses, which would be significant and, therefore, preventative for this method to be used in the system of FIG. 1, are mitigated by virtue of the cryogen that is communicated to the electrical conduit 140. The electrical conduit 140 may be made superconducting by the communication of cryogen to the electrical conduit 140 by the cryogenic system 130. The electrical conduit 140 may be an electrical bus.

The motor 120 in the arrangement 100 converts the electrical energy from the fuel cell 110 through the movement of charge (current) into a magnetic field where the current density is the limiting factor on magnetic field strength and hence torque. In order to increase the torque, the current density and therefore cooling is increased. With greater cooling of the electrical bus 140 therefore a more efficient arrangement 100 is provided. In an embodiment, the voltage is very low and the current is very high. The voltage may be used to modulate the field. This can be supported by a cryogenically cooled or a high temperature superconducting arrangement of the electrical bus 140.

The electrical bus 140 may be a high power electrical bus 140 so as to allow passage of high current electrical power produced from the fuel cell 110. The electrical bus 140 may have to carry very high current density, i.e. a high number of amps per unit area sent directly into the fuel windings. The system 100 may utilise a form of voltage control on the field windings of the motor 120 so as to be able to control the activation and deactivation of the motor 120. Materials that may be used for the electrical bus include conductive elements such as copper, aluminium, graphene or superconducting (and high temperature superconducting) bus bar, cables, wires or litz e.g. magnesium Boride (MgB2) or the like.

The system 100 shown in FIG. 2 combines, in a synergistic manner, the function of a fuel cell 110 and a motor 120. This is such that the high current output of the fuel cell 110 may be directly fed into the field windings of the motor 120. Furthermore, the cryogen contained in the cryogenic system 130 may be communicated to the fuel cell 110, the motor 120 and the electrical bus 140 to improve electrical efficiencies and the like. There is no need for transformers to step up or down the electrical power produced by the fuel cell 110.

As such, the electric current produced, or output, by the fuel cell 110 is substantially the same as the current that enters, or is input into, the motor 120. Further, the electric current produced, or output, by the fuel cell 110 is substantially the same as the current that is carried along the electrical bus 140.

“Substantially” has been used here, as the electrical bus may not, in practice, be perfectly superconducting, but rather, in an example, any imperfections in the electrical bus 140 may lead to some degradation in the current (even if minor), in the form of thermal losses along the length of the electrical bus 140. Such imperfections may stem from e.g. defects in manufacturing or impurities or the like. In another example, imperfections in the cryogenic system 130 and delivery of cryogen may lead to the electrical bus 140 not being perfectly superconducting during the entire duration of its use. As such, some small low level change in the current may occur in practice between the fuel cell 110 and the motor 120 due to these minor losses. However, “substantially” should be interpreted as in contrast to the modern system which involves an active step (e.g. via transformers) of altering the current prior to passing along the electrical conduit 140. Such an active alteration step has, in an example, been rendered redundant due to the novel arrangement disclosed herein. In an example, an inverter 118 may be placed between the fuel cell 110 and the motor 120, see FIG. 2b.

In this way, over the modern arrangement 10 shown in FIG. 1, the present disclosure, an example of which is shown in FIG. 2, provides a series of advantages. In particular, the disclosed arrangement 100 reduces the complication and expense of inclusion of these elements. Furthermore, this in turn improves the reliability and efficiency of the system 100.

The fuel cell 110 may be a fuel cell stack 110 containing a plurality of fuel cells. The plurality of fuel cells 110 in a stack may be optimised for high current transfer and share the same structure as (i.e. integrated with) the motor stator 122 housing. The output of the fuel cell stack 110 may be DC, and the field windings may also be DC.

The motor 120 may have a power electronic motor drive which is a controller to control the machine such as an inverter, allowing for control of current (more or less or none etc.) put into the stator coils. The shaft output may be used for electrical propulsion or to drive compressors and /or turbines or the like as part of an environmental control system. The stator 122 of the motor 120 may be a cryostator. This may result from a cryogenically cooled stator coil or windings, or a cooling of the stator as a whole. The advantage in cooling just the coils is a reduced use of cryogen to provide the cooling. Therefore, there is a saving in the amount of cryogen used. Furthermore, the cooled coils can be thermally isolated from e.g. the rotor to further reduce requirement of cryogen to maintain a cryocooled coil set. The rotor 124 of the motor 120 may be a permanent magnet as this can be a cost effective way of producing the arrangement 100 shown in FIG. 2. In another example, the magnet may be a superconducting magnet (with cryogen provided by the cryogenic system 130) or a normal magnet (e.g. rare earth or ferrite core or the like).

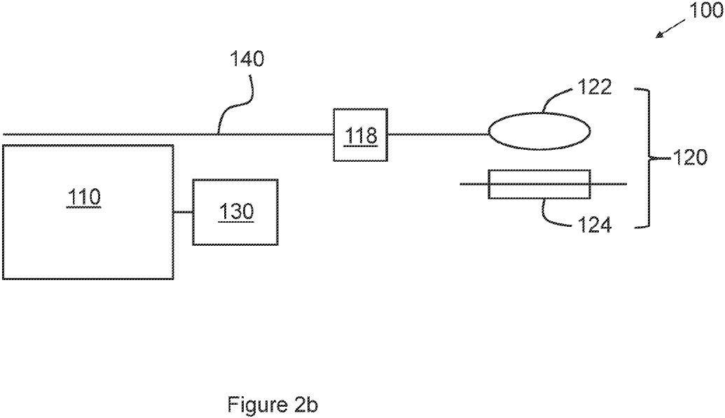

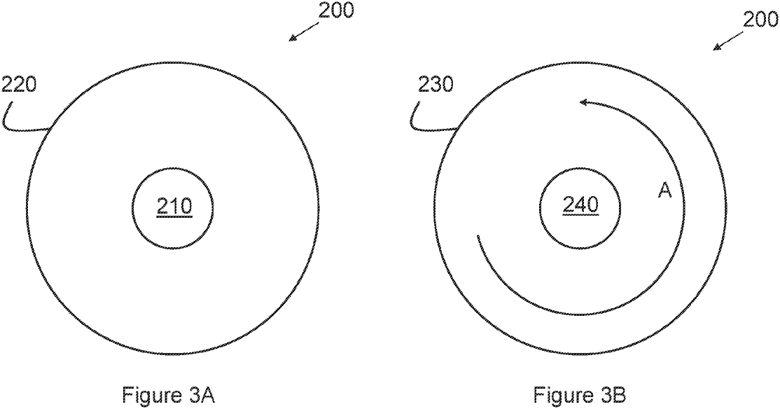

FIG. 3A shows a schematic of a portion 200 of a motor for a motor drive system according to an example of the present disclosure. FIG. 3A in particular shows an axi-symmetrical arrangement of a stator 210 and a rotor 220. The rotor 220 is an outer rotor 220. The stator 210 is arranged inwardly of the outer rotor 220. The cryogen in the cryogenic system may be pumped by a pumping device on the rotor 220 of the motor.

FIG. 3B shows a schematic of a portion 200 of a motor for a motor drive system according to an example of the present disclosure. FIG. 3B in particular shows an axi-symmetrical arrangement of a stator 230 and a rotor 240. The rotor 240 is an inner rotor 240. The inner rotor 240 is arranged inwardly of the stator 230. A direction of rotation of the inner rotor 240 is shown by arrow A. The cryogen in the cryogenic system may be pumped by a pumping device on the rotor 240 of the motor.

The present disclosure can be used with either of the arrangements of FIGS. 3A and 3B, but it may be preferable with 3B (rim-driven). This may be operated with a hollow and cylindrical structure or the like. In another arrangement, not shown, there is a singular rotor and a plurality of stators. In an example, the rotor is arranged inwardly of an outer stator and outwardly of an inner stator. In another arrangement, there may be a series of rotors arranged inwardly and outwardly of a series of stators, in an extension of the arrangements shown in FIGS. 3A and 3B.

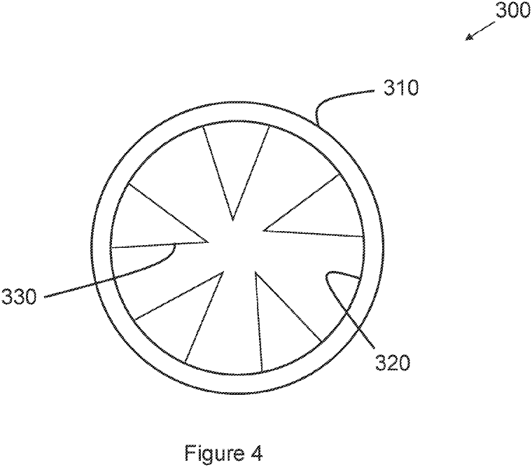

FIG. 4 shows a schematic of a portion 300 of a motor for a motor drive system according to an example of the present disclosure. FIG. 4, in particular, shows an asymmetrical arrangement of a stator 310 and a rotor 320. The arrangement in FIG. 4 is a rim-driven motor 300. The rotor 320 is an inner rotor 320. The stator 310 is arranged outwardly of the inner rotor 320. Also shown in FIG. 4 are blades 330 of a rim driven fan.

The motor drive system arrangement described herein may optionally have a cryocooler for performing heat exchange to condense vaporised liquid cryogen back into liquid cryogen. Use of a cryocooler may reduce the amount of cryogen that is ultimately lost during a particular flight, and as such can reduce the running costs of the arrangement. In an example of the arrangement where there is no cryocooler present, vaporised cryogen may be returned to the bulk source to condense back to liquid form. It may alternatively or additionally be used as fuel for the fuel cell.

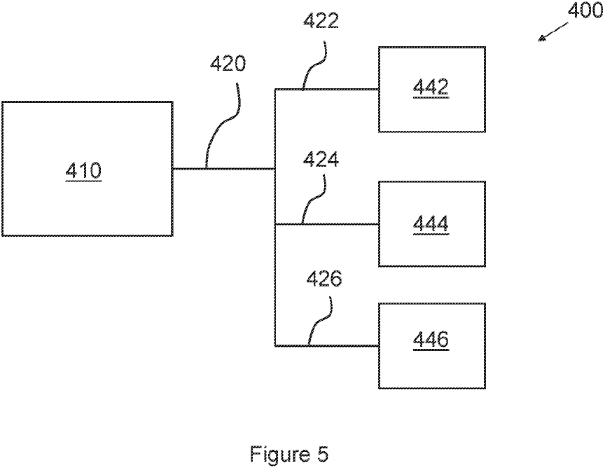

FIG. 5 shows a schematic arrangement of a motor drive system 400 according to an example of the present disclosure. The motor drive system 400 shown has a fuel cell 410, a branching electrical bus (or series of electrical buses) 420, 422, 424, 426 and a plurality of motors 442, 444, 446. The electrical bus 420 that projects from the fuel cell branches into three different branches (or different buses) 422, 424, 426. Each of these branches 422, 424, 426 joins a respective motor 442, 444, 446. In this arrangement, the fuel cell 410 may provide electrical power to a plurality of motors 442, 444, 446. In this way, propulsion may be generated at a number of different locations within the vehicle in which this motor drive system 400 is arranged. This may enable an efficient distribution of propulsion and therefore more efficient propulsion which, in turn, may lower the requirement on resources provided to the fuel cell to generate propulsion.

Furthermore, the cryogen provided to the electrical bus 420, 422, 424, 426 ensures that electrical power may be carried over long distances without incurring high electrical losses. This enables the use of one fuel cell 410 to provide power to a plurality of motors 442, 444, 446 alongside those motors being distributed in advantageous locations within the vehicle. This therefore reduces the cost of using a plurality of fuel cells and increases the reliability of the system as a whole.

In an example, each of the bus portions 420, 422, 424, 426 may have a switch for controlling passage of electrical power. Alternatively or additionally, some combination of the bus portions 420, 422, 424, 426 may have switches for controlling passage of electrical power to a specific motor 442, 444, 446 or specific combination of motors 442, 444, 446. In this way, motors may be selectively and controllably activated based on the required propulsion. E.g. a user may need full power to be provided across all motors and therefore select all switches to be closed. However, for more precise movement, the user may opt to have only certain motors activate since propulsion will be generated from the specific location of that those certain motors.

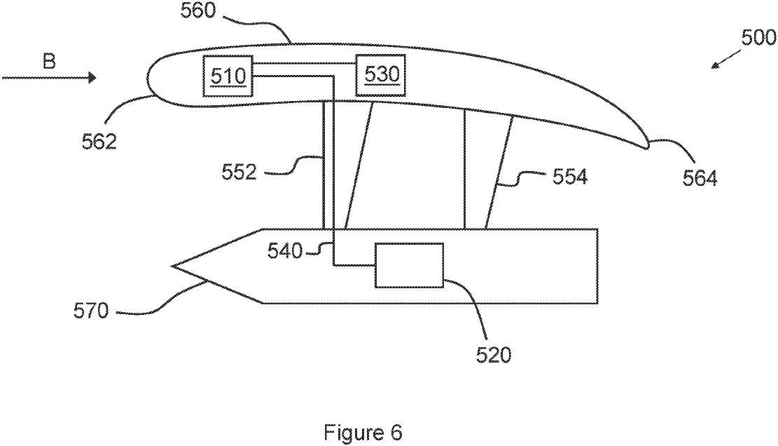

In a specific example, the motor drive system disclosed herein may be used in an aircraft. FIG. 6 shows a schematic of a motor drive system according to an example of the present disclosure arranged within a portion of an aircraft 500. The portion of the aircraft 500 contains part of a nacelle 560 and an inner shaft 570, which may be a centre sting. The motor drive system has a fuel cell 510, a motor 520, a cryogenic system 530 and an electrical bus 540, as described in detail above. The motor drive system components interact substantially as described in earlier examples. The fuel cell 510 is located in the nacelle and away from the gas path as this is a thermal advantageous location for the fuel cell 510. Airflow indicated by arrow B passes over and through the nacelle leading to locations of different temperatures which can advantageously be used for locating elements of the motor drive system described herein.

The electrical bus 540 is shown passing through a guide vane 552. The electrical bus 540 may pass through any of the plurality of guide vanes 552, 554 in the nacelle 560. In the specific arrangement shown, the cryogenically cooled electrical bus 540 may cool the outlet guide vanes from the exhaust gases that may pass through the nacelle. In a similar manner, thermal control to prevent icing occurring may be provided in the form of water channels through the outlet guide vanes, with water flowing through said channels. A de-icing function may also be provided by such water channels.

The motor 520 may be supplied with cryogen from the cryogenic system 530. The motor 520 therefore may be a fully superconducting motor. As described above, this may improve the efficiency of the motor 520 during use.

In the example of FIG. 6, the fuel cell 510 is arranged in a nacelle 560. The fuel cell 510 may also be arranged within the fuselage of an aircraft. It may be beneficial to locate the fuel cell 510 in a nacelle 560, as heat can be input to the nacelle 560 itself from the fuel cell 510. This may be via heat exchangers or the like. This may increase the thermodynamic energy of the air flow and therefore provide more thrust from the nacelle 560. This heat energy may also or alternatively be used for de-icing or the like of the nose. There may also be a beneficial impact on the pressure distribution of the nacelle 560, and this also provides a use of the low quality heat from fuel cell 510.

The fuel cell may instead be located in centre body 570. Location of fuel cell 510 after fan blades may be advantageous, this will confine noise output and improves aerodynamics over use in fuselage.

The fuel cell may be located in the fuselage of an aircraft. This may be advantageous as it provides the benefit of full integration of fuel cell 510 and motor 520. This may reduce transmission losses but there may then be a need to transmit fluids from one to the other. As mentioned above, in relation to the nacelle, similar advantages can be obtained by location in the fuselage of the fuel cell. For example, heat exchange into the boundary layer may improve aerodynamic efficiency as well as leading to added efficiencies in downstream propulsors, such as a boundary layer ingestor.

As fuel cells require a relatively large amount of volume to be stored, fuel cells may be advantageously placed in nacelle or large fuselage area or the wing, where there is a large volume to accommodate the fuel cells.

There may be a ballast tank located in the aircraft to prevent water being deposited to nearby inhabited locations. Therefore, holding the water in the ballast tank enables an option for the water to be stored in the ballast tank and not released. Release of water can be controllably selected so as to be appropriately removed from the aircraft.

In the example described herein, the field windings of the motor can be part of a cryogenically cooled conventional, or high temperature superconducting, asynchronous machine. This has an advantage of not requiring expensive magnets but also uses the high magnetic field density capability of cryogenic or high temperature superconducting windings. The stator of the motor may then be driven at constant or stepped (depending upon power demand) current densities reflecting different fuel cell operating conditions. Such conditions may be e.g. nominal power for all conditions except takeoff or emergency power for takeoff or one engine inoperative (OEI) conditions. Use of an asynchronous machine with a variable frequency drive means the rotor torque and velocity vectors can be modified to suit the vehicle demands. This could support also energy recovery and reverse speed operation. This arrangement therefore provides a significant amount of control to a user of the motor drive system disclosed herein.

In the present solution, rather than a use of air cooling for the stack, an oxidant is used as the cooling mechanism. This results in a less complex, smaller and lighter stack. As the oxidant is used as a coolant mechanism, the propulsion gas path is not interrupted and therefore the arrangement operates at higher efficiency. The cryogenic fuel is used to allow that one or both of the reactant (gas from the cryogenic fuel) and oxidant may provide a cooling function.

In the present solution, skin heat exchangers are used on the boundary of the gas path to the cowling in order to dissipate heat into the flow. This will have an effect in increasing the flow energy but without any associated aerodynamic losses. Once the cryogen is heated up from cooling various elements of the motor drive system disclosed herein, the resulting non-cryogen may be used as a fuel for the fuel cell (or fuel cell stack). This further increases the overall efficiency of the arrangement.

The efficiencies provided by the system as described herein, in contrast to the 92% for the arrangement of FIG. 1, are as high as 99.8%. As such, this is a significant improvement on modern systems. This directly leads to a drop in the resources required to produce propulsion and therefore has a direct improvement on the environment through which the motor drive system passes. Similarly, the arrangement shown has significant financial benefits for the user of the motor drive system.

As such, there is provided herein a motor drive system comprising: a fuel cell; a motor, electrically connected to the fuel cell; and, a cryogenic system arranged to contain a cryogen, wherein the fuel cell is arranged to output current to the motor, and wherein the cryogenic system is arranged to provide a cryogen contained in the cryogenic system to the fuel cell.

Components of the system may be arranged in various locations in the aircraft. For example, it is advantageous to avoid freezing in the drive system. As such, location of the elements of the drive system should be considered to prevent freezing.

Arrangement of the motor drive system within the aircraft may allow advantage to be taken of other effects, such as the hot thermal areas and the cold thermal areas of the aircraft. For example, the hot areas can be used to provide thermal energy to portions of the system (e.g. to the fuel cell to avoid freezing) while the cooler areas can be used to remove thermal energy from the system (e.g. to assist in cooling electronic components to increase efficiencies).

Furthermore, the use of a fuel cell to provide electrical power results in only the emission of H₂O, as opposed to harmful gaseous emissions produced by standard combustion engines. This H₂O may be captured and used within the aircraft as potable or non-potable H₂O.

The arrangement as described herein may be part of an aircraft propulsion apparatus which may include for example a propeller or propeller arrangement or the like to generate thrust.

1-28. (canceled)

29. A system comprising:
a fuel cell;
a motor, electrically connected to the fuel cell; and,
a cryogenic system arranged to contain a cryogen;
wherein the fuel cell is arranged to output current to the motor,
and wherein the cryogenic system is arranged to communicate a cryogen from the cryogenic system to the fuel cell.

30. The system of claim 29, wherein the cryogenic system is arranged to communicate a cryogen to the motor to cause a reduction in a temperature of the motor.

31. The system of claim 29, wherein the motor is electrically connected to the fuel cell by an electrical bus, the cryogenic system arranged to communicate a cryogen to the electrical bus to cause a reduction in a temperature of the electrical bus.

32. The system of claim 31, wherein the electrical bus comprises at least one switch and/or at least one inverter.

33. The system of claim 31, wherein the electrical bus lacks a transformer.

34. The system of claim 29, wherein the current output by the fuel cell is the same as the current input to the motor.

35. The system of claim 34, wherein the current output by the fuel cell is the same as the current along the electrical bus.

36. The system of claim 29, wherein the motor comprises a stator and a rotor.

37. The system of claim 36, wherein the stator is a cryostator.

38. The system of claim 36, wherein the motor comprises at least one of:
a permanent magnet; and,
an induction motor.

39. The system of claim 36, the motor comprising an inner rotor and an outer rotor, the inner rotor arranged inwardly of the stator and the stator arranged inwardly of the outer rotor.

40. The system of claim 29, comprising a plurality of motors wherein the fuel cell is arranged to output current to each of the plurality of motors.

41. The system of claim 29, comprising a plurality of fuel cells, wherein each fuel cell is arranged to output current to one or more coils of the motor.

42. The system of claim 29, comprising a plurality of motors and a plurality of fuel cells, wherein each fuel cell is arranged to output current to one or more coils of one or more of the plurality of motors.

43. The system of claim 29, further comprising an aircraft that includes the fuel cell, the motor, and the cryogenic system.

44. The system of claim 43, wherein the fuel cell is arranged within a fuselage of the aircraft.

45. The system of claim 43, wherein the fuel cell is arranged within a nacelle of the aircraft.

46. The system of claim 43, wherein the fuel cell is arranged within a fuselage of the aircraft and a nacelle of the aircraft.

47. An aircraft propulsion apparatus comprising:
a propeller arranged to generate thrust on rotation in air; and,
a motor drive system arranged to cause rotation of the propeller, the motor drive system comprising:
a fuel cell;
a motor, electrically connected to the fuel cell; and,
a cryogenic system arranged to contain a cryogen,
wherein the fuel cell is arranged to output current to the motor, and wherein the cryogenic system is arranged to communicate a cryogen from the cryogenic system to the fuel cell.
